(19) United States
(12) Patent Application Publication
(10) Pub. No.: US 2022/0413794 A1
(43) Pub. Date: Dec. 29, 2022

(54) VIRTUAL MEETING CONTROL

(71) Applicant: Citrix Systems, Inc., Ft. Lauderdale, FL (US)

(72) Inventors: Zongpeng Qiao, Nanjing (CN); Tao Zhan, Nanjing (CN); Ze Chen, Nanjing (CN); Ke Xu, Nanjing (CN)

(73) Assignee: Citrix Systems, Inc., Ft. Lauderdale, FL (US)

(21) Appl. No.: 17/381,331

(22) Filed: Jul. 21, 2021

Related U.S. Application Data
(63) Continuation of application No. PCT/CN2021/101728, filed on Jun. 23, 2021.

(51) Int. Cl. G06F 3/16; G10L 25/51; H04L 29/06; G08B 5/22; G06F 9/451

(52) U.S. Cl. CPC G06F 3/165; G10L 25/51; H04L 65/403; G08B 5/22; G06F 9/452

(57) ABSTRACT

A method for controlling a virtual meeting includes receiving a meeting template including at least one rule. The rule or rules associated with the meeting template define a first time period relating a first virtual meeting session of a first endpoint computing device and a second time period relating to a second virtual meeting session of a second endpoint computing device. The method further includes causing, responsive to the rule(s), a first audio mute/unmute action to occur in the first virtual meeting session at or prior to an expiration of the first time period. The method further includes causing a second audio mute/unmute action to occur in the second virtual meeting session at or prior to a start of the second time period, where the second time period is different from with the first time period.

### RELATED APPLICATIONS

This application claims priority under 35 U.S.C. § 120 as a continuation of PCT Application No. PCT/CN2021/101728, entitled “VIRTUAL MEETING CONTROL” and filed Jun. 23, 2021. PCT Application No. PCT/CN2021/101728 is hereby incorporated herein by reference in its entirety.

### BACKGROUND

Virtual collaboration products are computer-implemented tools that facilitate online sharing and exchange of audio, video, and other types of data between users. One of the most common types of virtual collaboration is a virtual meeting, where multiple attendees, or participants, can communicate with each other in real-time through an audio/video conference even when the participants are not physically situated in the same location. Existing virtual meeting products may only permit one participant at a time to speak audibly. For example, while one participant is speaking, the audio from all other participants may be muted; otherwise, if multiple participants are speaking simultaneously, it can be very difficult to comprehend what any of the participants are saying due to interference. To address this, the meeting participants may voluntarily choose to speak one at a time so that everyone can hear them as clearly as possible. This requires coordination between the participants. For example, the participants may agree to speak, one at a time, in a pre-determined order so that each of them has an opportunity to participate in the meeting. To manage the length of the meeting, the participants may further agree to limit how much time each is allowed to speak in turn. However, such voluntary coordination requires all of the participants to abide by the agreements, to keep track of which participant is allowed to speak and when, and to stop speaking when their allocated speaking times have expired. In practice, such voluntary coordination is difficult to achieve routinely, thus leading to frequent situations where participants speak out of order or for more than their allotted times. Furthermore, existing virtual meeting products do not provide the ability to manage this coordination from within the product, requiring participants to devise separate mechanisms for arranging and enforcing the coordination. Therefore, there remain non-trivial problems associated with controlling virtual meetings.

### SUMMARY

One example provides a method for controlling a virtual meeting. The method includes receiving, by a virtual desktop application executing on an endpoint computing device, a virtual meeting template including at least one template rule. The at least one template rule defines a first time period relating a first virtual meeting session of a first endpoint computing device and a second time period relating to a second virtual meeting session of a second endpoint computing device. The method further includes causing, by the virtual desktop application responsive to the at least one template rule, a first audio mute/unmute action to occur in the first virtual meeting session at or prior to an expiration of the first time period, and causing, by the virtual desktop application responsive to the first audio mute action, a second audio mute/unmute action to occur in the second virtual meeting session at or prior to a start of the second time period, where the second time period is different from the first time period.

At least some examples of the method include one or more of the following. The first audio mute/unmute action includes causing an audio input on the first endpoint computing device to become muted in the first virtual meeting session and/or causing a first notification user interface element to be displayed in the first virtual meeting session of the first endpoint computing device. The method further includes detecting audio silence at the audio input during the first time period, where the first audio mute/unmute action occurs in response to detecting the audio silence. The first audio mute/unmute action further includes causing the audio input on the first endpoint computing device to become unmuted in the first virtual meeting session at a start of the first time period. The second audio mute/unmute action includes causing an audio input on the second endpoint computing device to become unmuted in the second virtual meeting session in response to causing an audio input on the first endpoint computing device to become muted in the first virtual meeting session, and/or causing a second notification user interface element to be displayed in the second virtual meeting session of the second endpoint computing device. The second audio mute/unmute action further includes causing the audio input on the second endpoint computing device to become muted in the second virtual meeting session at an expiration of the second time period. The method further includes selecting the virtual meeting template from among a plurality of virtual meeting templates by matching one or more parameters of the virtual meeting to one or more parameters of the virtual meeting template using a natural language processor. The method further includes receiving a user input modifying the first time period, the second time period, or both.

Another example provides a computer program product including one or more non-transitory machine-readable mediums having instructions encoded thereon that when executed by at least one processor cause a process to be carried out. The process includes receiving, by a virtual desktop application, a virtual meeting template including at least one template rule, the at least one template rule defining a first time period relating a first virtual meeting session of a first endpoint computing device and a second time period relating to a second virtual meeting session of a second endpoint computing device; causing, by the virtual desktop application responsive to the at least one template rule, a first audio mute/unmute action to occur in the first virtual meeting session at or prior to an expiration of the first time period; and causing, by the virtual desktop application responsive to the first audio mute action, a second audio mute/unmute action to occur in the second virtual meeting session at or prior to a start of the second time period, the second time period being different from the first time period.

At least some examples of the computer program product include one or more of the following. The first audio mute/unmute action includes causing an audio input on the first endpoint computing device to become muted in the first virtual meeting session and/or causing a first notification user interface element to be displayed in the first virtual meeting session of the first endpoint computing device. The process further includes detecting audio silence at the audio input during the first time period, where the first audio mute/unmute action occurs in response to detecting the audio silence. The first audio mute/unmute action further includes causing the audio input on the first endpoint computing device to become unmuted in the first virtual meeting session at a start of the first time period. The second audio mute/unmute action includes causing an audio input on the second endpoint computing device to become unmuted in the second virtual meeting session in response to causing an audio input on the first endpoint computing device to become muted in the first virtual meeting session, and/or causing a second notification user interface element to be displayed in the second virtual meeting session of the second endpoint computing device. The second audio mute/unmute action further includes causing the audio input on the second endpoint computing device to become muted in the second virtual meeting session at an expiration of the second time period. The process further includes selecting the virtual meeting template from among a plurality of virtual meeting templates by matching one or more parameters of the virtual meeting to one or more parameters of the virtual meeting template using a natural language processor.

Another example provides a system including a storage and at least one processor operatively coupled to the storage. The at least one processor is configured to execute instructions stored in the storage that when executed cause the at least one processor to carry out a process including receiving, by a virtual desktop application, a virtual meeting template including at least one template rule, the at least one template rule defining a first time period relating a first virtual meeting session of a first endpoint computing device and a second time period relating to a second virtual meeting session of a second endpoint computing device; causing, by the virtual desktop application responsive to the at least one template rule, a first audio mute/unmute action to occur in the first virtual meeting session at or prior to an expiration of the first time period; and causing, by the virtual desktop application responsive to the first audio mute action, a second audio mute/unmute action to occur in the second virtual meeting session at or prior to a start of the second time period, the second time period being different from the first time period.

At least some examples of the system include one or more of the following. The first audio mute/unmute action includes causing an audio input on the first endpoint computing device to become muted in the first virtual meeting session and/or causing a first notification user interface element to be displayed in the first virtual meeting session of the first endpoint computing device. The process further includes detecting audio silence at the audio input during the first time period, wherein the first audio mute/unmute action occurs in response to detecting the audio silence. The first audio mute/unmute action further includes causing the audio input on the first endpoint computing device to become unmuted in the first virtual meeting session at a start of the first time period. The second audio mute/unmute action includes causing an audio input on the second endpoint computing device to become unmuted in the second virtual meeting session in response to causing an audio input on the first endpoint computing device to become muted in the first virtual meeting session, and/or causing a second notification user interface element to be displayed in the second virtual meeting session of the second endpoint computing device, and wherein the second audio mute/unmute action further includes causing the audio input on the second endpoint computing device to become muted in the second virtual meeting session at an expiration of the second time period.

Other aspects, examples, and advantages of these aspects and examples, are discussed in detail below. It will be understood that the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a virtual collaboration system, in accordance with an example of the present disclosure.

FIG. 2 is a flow diagram of an example virtual meeting control sequence that can be implemented in the virtual collaboration system of FIG. 1, in accordance with an example of the present disclosure.

FIG. 3 is a data flow diagram of an example virtual meeting control sequence that can be implemented in the virtual collaboration system of FIG. 1, in accordance with an example of the present disclosure.

FIGS. 4A-C show a flow diagram of an example virtual meeting control process that can be implemented in the virtual collaboration system of FIG. 1, in accordance with an example of the present disclosure.

FIGS. 5A-B each show an example timeline corresponding to execution of one or more rules during a virtual meeting, in accordance with an example of the present disclosure.

FIGS. 6A-B each show another example timeline corresponding to execution of one or more rules during a virtual meeting, in accordance with an example of the present disclosure.

FIGS. 7, 8, 9, and 10 are flow diagrams of several example virtual meeting control processes that can be implemented in the virtual collaboration system of FIG. 1, in accordance with an example of the present disclosure.

### DETAILED DESCRIPTION

As summarized above, virtual meetings can be difficult to manage. For example, there can be many different types of virtual meetings, such as a daily scrum_meeting, a brainstorming meeting, a sharing meeting, etc. Each type of meeting should follow some set of rules that define how meeting time is managed to ensure that the meetings are conducted effectively and efficiently and are not unproductive or wasting time. For example, a good practice for a daily scrum_meeting is to keep meeting duration at about 15 minutes. Furthermore, in a daily scrum meeting, each meeting participant should focus on sharing short status updates. For a detailed discussion of any issues, a separate meeting should be scheduled with the relevant participants. Otherwise, the scrum_meeting may have multiple participants who would prefer to speak freely and at length, which can be disruptive and an inefficient use of everyone's time. Relying on the attendees to manage the virtual meeting is not always practical and can also make the meeting experience unpleasant, unproductive, and inefficient.

To this end, examples of the present disclosure provide a virtual collaboration system and, more particularly, techniques for controlling a virtual meeting with endpoint sessions for the organizers and attendees. For example, a method for controlling a virtual meeting includes receiving a meeting template including at least one rule. The rule or rules associated with the meeting template define a first time period relating a first virtual meeting session of a first endpoint computing device and a second time period relating to a second virtual meeting session of a second endpoint computing device. A first virtual meeting attendee speaks via the first virtual meeting session during the first time period, and a second virtual meeting attendee speaks via the second virtual meeting session during the second time period. It will be understood that this technique can be extended to include any number of meeting attendees or participants. The method further includes causing, responsive to the rule(s), a first audio mute/unmute action to occur in the first virtual meeting session at or prior to an expiration of the first time period. For example, the audio of the first virtual meeting session is unmuted at the beginning of the first time period and muted at the expiration of the first time period. The method further includes causing a second audio mute/unmute action to occur in the second virtual meeting session at or prior to a start of the second time period, where the second time period is different from with the first time period. For example, the audio of the second virtual meeting session is unmuted at the beginning of the second time period, which coincides with the expiration of the first time period, or earlier if the first virtual meeting attendee has been silent for a certain amount of time (e.g., if the first attendee is not speaking during his or her allocated speaking time, then the first attendee will be muted before his or her time expires so that the second attendee can begin speaking early). Various examples will be apparent in light of the present disclosure.

### Example Virtual Collaboration System

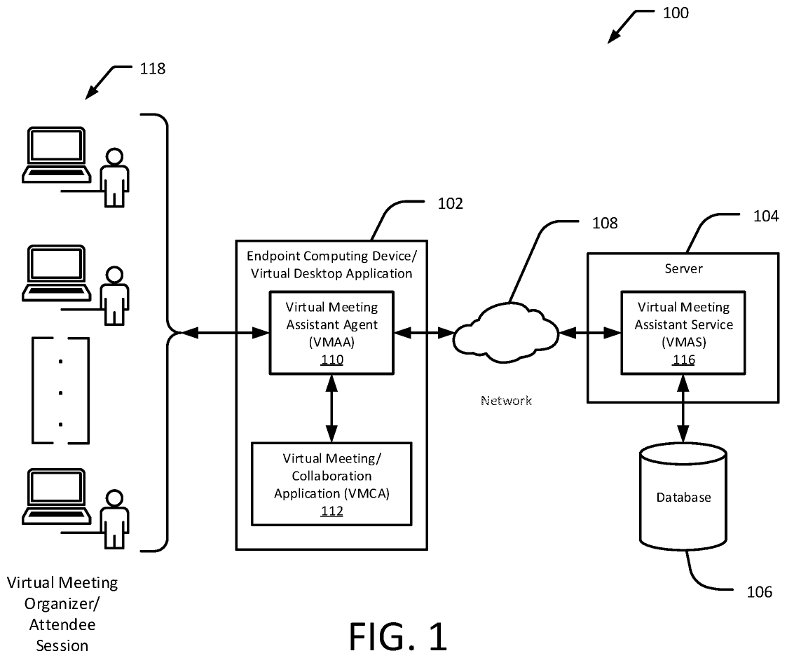

FIG. 1 is a block diagram of a virtual collaboration system 100, in accordance with an example of the present disclosure. The system 100 includes an endpoint computing device 102, a server 104, a database 106, and a communication network 108. The endpoint computing device 102 can be a physical device, such as a personal computer, or a virtual device, such as a virtual desktop executing on a server or other remote computing device and accessible via an endpoint computing device. The endpoint computing device 102 is configured to execute a Virtual Meeting Assistant Agent (VMAA) 110 and a Virtual Meeting/Collaboration Application (VMCA) 112. The server 104 is configured to execute a Virtual Meeting Assistant Service (VMAS) 116. The VMCA 112 is configured to host one or more virtual meeting organizers and/or attendee sessions 118. Each of the sessions 118 provides the users with access to a virtual meeting from their endpoint computing devices.

The VMAA 110 works in conjunction with the VMCA 112 to provide functions and features as variously described in this disclosure, including but not limited to one or more meeting user interface elements and audio mute/unmute controls for each of the sessions 118. The VMCA 112 can include any application configured to provide a virtual collaboration or meeting environment via the endpoint computing device 102. For example, the VMCA 112 can support one or more sessions 118 for any VMAS 116, such as GoToMeeting®, Skype®, Slack®, Google Hangouts®, Zoom®, Microsoft Teams®, Google® Meeting, Cisco WebEx®, or other computer software configured to create, host, and deliver online conferences, meetings, demonstrations, tours, presentations, and discussions among multiple participants, including organizers and attendees. The database 106 can include any data storage device configured to service the VMAS 116. The communication network 108 can include any type of network, including a local area network and a wide area network, such as the Internet or an intranet.

In some cases, the endpoint computing device 102 can be a workstation, a laptop computer, a tablet, a mobile device, or any suitable computing or communication device. The endpoint computing device 102 may also be referred to as a computer or a computer system. The endpoint computing device 102 includes one or more processors, volatile memory (e.g., random access memory (RAM)), non-volatile machine-readable mediums (e.g., memory), one or more network or communication interfaces, a user interface (UI), a display screen, and a communications bus. The non-volatile (non-transitory) machine-readable mediums can include: one or more hard disk drives (HDDs) or other magnetic or optical machine-readable storage media; one or more machine-readable solid state drives (SSDs), such as a flash drive or other solid-state storage media; one or more hybrid machine-readable magnetic and solid-state drives; and/or one or more virtual machine-readable storage volumes, such as a cloud storage, or a combination of such physical storage volumes and virtual storage volumes or arrays thereof. The user interface can include one or more input/output (I/O) devices (e.g., a mouse, a keyboard, a microphone, one or more speakers, one or more biometric scanners, one or more environmental sensors, and one or more accelerometers, etc.). The display screen can provide a graphical user interface (GUI) and in some cases, may be a touchscreen or any other suitable display device. The non-volatile memory stores an operating system (OS), one or more applications, and data such that, for example, computer instructions of the operating system and the applications, are executed by processor(s) out of the volatile memory. In some examples, the volatile memory can include one or more types of RAM and/or a cache memory that can offer a faster response time than a main memory. Data can be entered through the user interface. Various elements of the endpoint computing device 102 can communicate via the communications bus.

The endpoint computing device 102 described herein is an example computing device and can be implemented by any computing or processing environment with any type of machine or set of machines that can have suitable hardware and/or software capable of operating as described herein. For example, the processor(s) of the endpoint computing device 102 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals. In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory. The processor can be analog, digital, or mixed. In some examples, the processor can be one or more physical processors, which may be remotely located or local. A processor including multiple processor cores and/or multiple processors can provide functionality for parallel, simultaneous execution of instructions or for parallel, simultaneous execution of one instruction on more than one piece of data.

The network interfaces can include one or more interfaces to enable the endpoint computing device 102 to access a computer network such as a Local Area Network (LAN), a Wide Area Network (WAN), a Personal Area Network (PAN), or the Internet through a variety of wired and/or wireless connections, including cellular connections. In some examples, the network may allow for communication with other computing platforms, to enable distributed computing. In some examples, the network 108 may allow for communication with the server 104, the database 106, and/or other parts of the system 100 of FIG. 1.

### Example Virtual Meeting Control Sequence

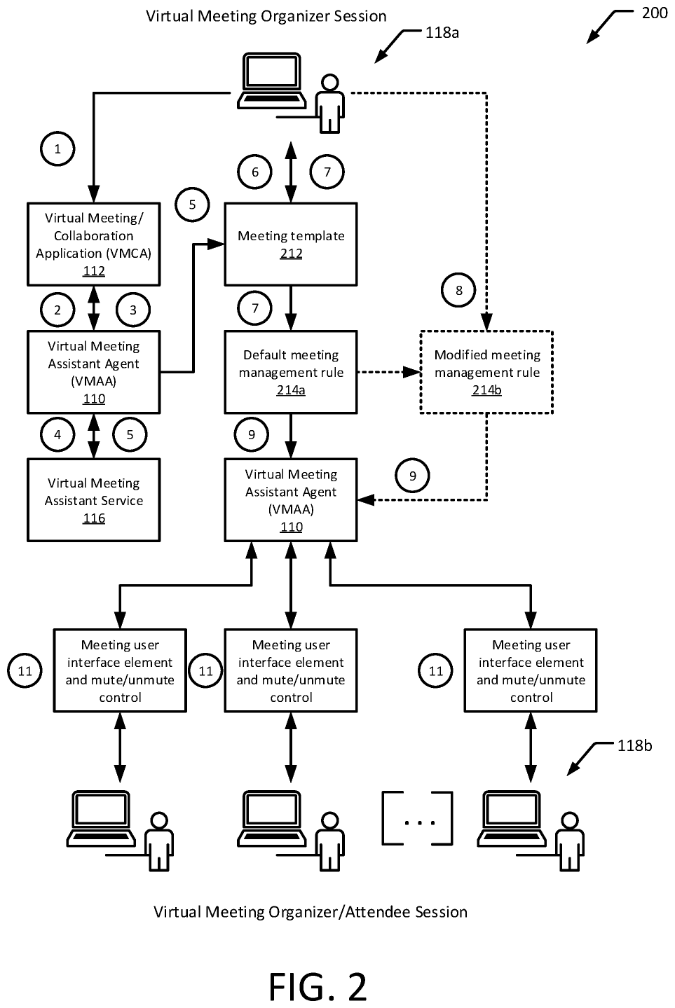

FIG. 2 is a flow diagram of an example virtual meeting control sequence 200, in accordance with an example of the present disclosure. At step 1, a virtual meeting organizer session 118a is initiated by launching the VMCA 112. At step 2, the VMAA 110 is launched in response to the launch of the VMCA 112. At step 3, the VMAA 110 requests meeting context information from the VMCA 112. The meeting context information includes data representing the virtual meeting, including, for example, participant names (or other identifying information), the date/time of the meeting, the subject of the meeting, and any other data corresponding to or otherwise describing or defining the virtual meeting. At step 4, the VMAA 110 sends the meeting context information to a virtual meeting assistant service (VMAS) 116 along with a meeting template request. The VMAS 116 performs an analysis of the meeting context information (such as by using a natural language process to compare the meeting context information to one or more existing meeting templates and to choose the template that most closely matches the meeting context information) and selects, based on the analysis, a meeting template 212 from a set of pre-defined templates for different types of meetings (e.g., scrum meeting, planning meeting, brainstorming meeting, etc.). The selected meeting template 212 includes one or more rules, such as described in further detail below, that can be used by the VMAA 110 to control the virtual meeting. At step 5, the VMAS 116 sends a meeting template 212 to the VMAA 110.

At step 6, the meeting template 212 is provided to or otherwise shared with the virtual meeting organizer session 118a. At step 7, the virtual meeting organizer can, via the virtual meeting organizer session 118a, approve or otherwise accept the meeting template 212 as one or more default meeting management rules 214a. Alternatively, at step 8, the virtual meeting organizer can, via the virtual meeting organizer session 118a, provide a user input modifying the meeting template 212 to generate one or more modified meeting management rules 214b. In either case, at step 9, the default meeting management rule(s) 214a and/or the modified meeting management rule(s) 214b are passed to the VMAA 110 for further processing. The meeting management rules 214a, 214b can, for example, define the time when the audio for each of one or more virtual meeting sessions 118b is unmuted (at the beginning of a user's speaking period) and muted (at the end of a user's speaking period). The virtual meeting sessions 118b can include sessions for the meeting organizer and/or any number of meeting attendees via each of their respective endpoint computing devices 102. At step 11, for each of one or more virtual meeting sessions 118b, the VMAA 110 controls (via the VMCA 112) the respective virtual meeting sessions 118b according to the meeting management rules 214a, 214b by, for example, displaying, or causing display of, one or more meeting user interface elements (e.g., a graphical user interface element that displays text and/or graphics) within the respective session 118b, and/or controlling the audio mute/unmute of the respective session 118b. In some other examples, the VMAA 110 controls (via the VMCA 112) the respective virtual meeting sessions 118b according to the meeting management rules 214a, 214b by notifying meeting attendees when their respective speaking times are scheduled to begin and/or end, to encourage meeting attendees to speak more frequently, to mute a meeting attendee who has not spoken for a pre-determined period of time, and/or to create sub-discussions/meetings for certain meeting attendees.

In accordance with some examples, the meeting template 212 can be defined by a data structure such as follows:

{

| | |
|---|---|
| “template_type”, | // Template type. |
| “rule”, | // Rule corresponding to the type. |
| “tolerance_coefficient” | // Tolerance coefficient for the speaker's |

timeout.
}

In the example data structure, “template_type” can be “scrum_meeting,” “session_sharing_meeting,” “brainstorming_meeting,” or any other meeting type that can be uniquely defined to represent the nature of the virtual meeting. For example, a “scrum_meeting” can be a relatively brief (e.g., about 15 minutes long) and regularly occurring (e.g., daily) meeting among a small group of attendees (e.g., 4-5 attendees); a “session_sharing_meeting” can be a longer (e.g., about 30 minutes long) and regularly occurring (e.g., weekly) meeting among a larger group of attendees (e.g., 5-10 attendees); and a “brainstorming_meeting) can be a relatively long (e.g., 1 hour long) and non-recurring (e.g., once) meeting among a large group of attendees (e.g., 10 or more attendees). Other such examples will be apparent.

The “rule” in the template is defined based on the “template_type” and represents a logical condition. The “rule” can be customized for a given type of virtual meeting. For example, the “rule” can be defined as “EVEN” where every attendee shares the same split of the whole meeting time, or “EVEN_EXCEPT_ONE” where one attendee is the main speaker and the rest share the same split of the rest meeting time. In this latter example, the organizer can customize the time for the major speaker and the VMAA 110 will calculate the time for the rest of the attendees. For the attendees, the rule can cause each speaker to be muted at the end of his or her speaking time, or the rule can display a notification that his or her speaking time has or is about to expire. In another example, the “rule” can be defined as “FREE” where the VMAA 110 calculates the same time split for all attendees. In this example, when the attendee is speaking overtime, the VMAA 110 will notify the attendee to let others have a turn speaking. In some examples, the VMAA 110 monitors the audio input for each attendee during their speaking time and notifies the attendee to begin or resume speaking if there is silence detected for a pre-determined period.

The “tolerance_coefficient” in the template defines how much time a meeting attendee is given after his or her speaking time has expired before the attendee's audio is muted by the VMAA 110. For example, if the “tolerance_coefficient” is 10 seconds, then the attendee's audio will be muted no more than 10 seconds after the attendee's speaking time has expired.

In some examples, the VMAS 116 uses a natural language process to compare the meeting context information to one or more existing meeting templates 212 and to choose the template that most closely matches the meeting context information. For example, parameters representing the meeting context information are mapped into a context vector using word2vec, which is a natural language processing model that is trained to associate words. Further, one or more of the meeting templates 112 are mapped into one or more template vectors using word2vec. Next, the similarity between the context vector and each template vector is used to find the meeting template 212 that most closely matches the meeting context information parameters. For example, if the similarity of the most closely matching template is larger than a threshold value such as 90%, then the corresponding template is provided to the VMAA 110; otherwise, no template is provided.

In some examples, the similarity is determined using a cosine similarity algorithm to calculate the similarity as follows:

$$cos θ = \frac{{\sum }_{i = 1}^{n} ( {A}_{i} \times {B}_{i} )}{\sqrt{{\sum }_{i = 1}^{n} {( {A}_{i} )}^{2}} \times \sqrt{{\sum }_{i = 1}^{n} {( {B}_{i} )}^{2}}} = \frac{A \cdot B}{\vert A \vert \times \vert B \vert}$$

For example, the word2vec can produce many 300-dimension vectors, where one of the vectors is the context vector and the other vectors are the template vectors, such as: {meeting context: [Vs1], templates A:[VsA], templates B:[VsB], . . . }. Then, the similarity between the context vector and each template vector is calculated to get the matching percentage for each one, such as: {cos A: [Vs1, VsA], cos B:[Vs1, VsB], . . . }.

### Example Virtual Meeting Control Sequence Data Flow

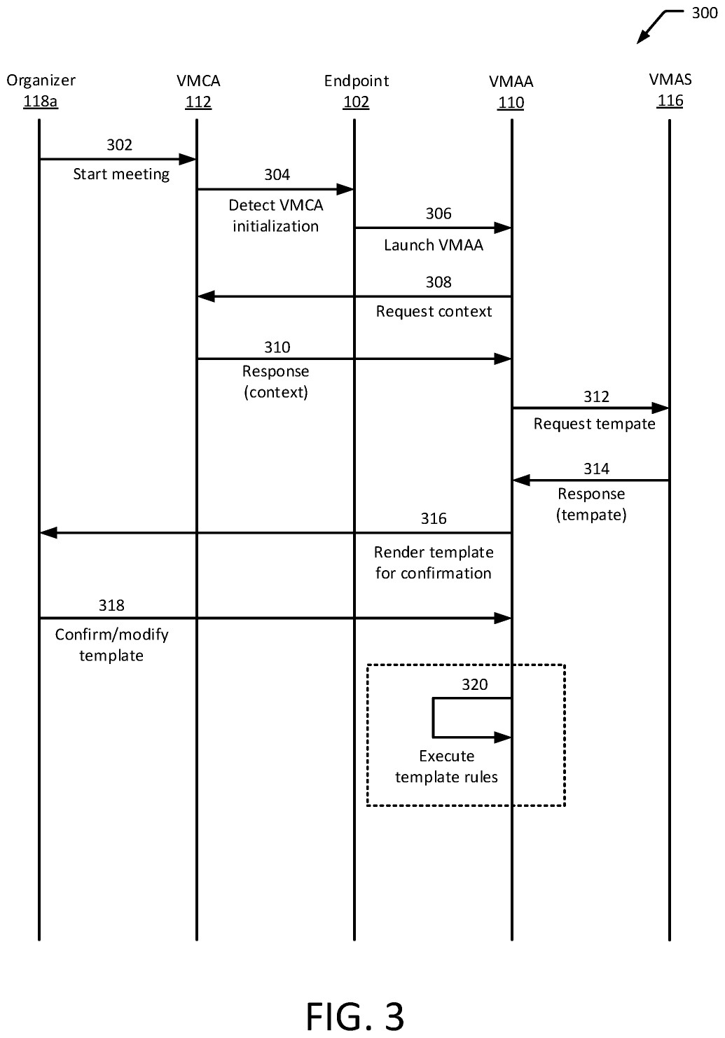

FIG. 3 is a data flow diagram of an example virtual meeting control sequence 300, in accordance with an example of the present disclosure. As noted above, the virtual meeting organizer session 118a is initiated by launching the VMCA 112 with a start meeting request 302, which initializes the VMCA 112. Next, the endpoint computing device 102 detects 304 initialization (launch) of the VMCA 112, for example, by monitoring a process table for execution of the VMCA. Upon detecting initialization of the VMCA 112, the endpoint computing device 102 launches 306 the VMAA 110. Next, the VMAA 110 requests 308 the virtual meeting context from the VMCA 112, which in turn sends a response 310 (the virtual meeting context data) to the VMAA 110. As noted above, the virtual meeting context can include data representing or otherwise describing the virtual meeting that was started by the organizer session 118a. Next, the VMAA 110 requests 312 the meeting template 212 from the VMAS 116, which in turn sends a response 314 (the meeting template 212) to the VMAA 110 after determining which (if any) existing meeting template most closely matches the meeting context.

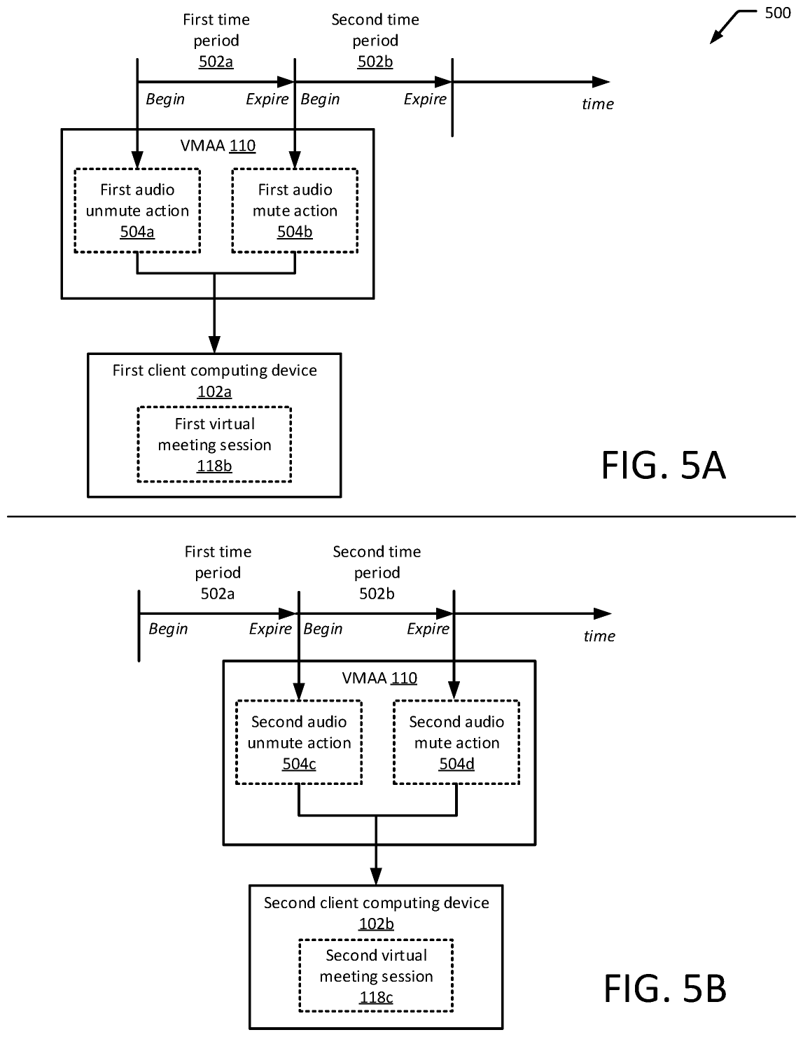

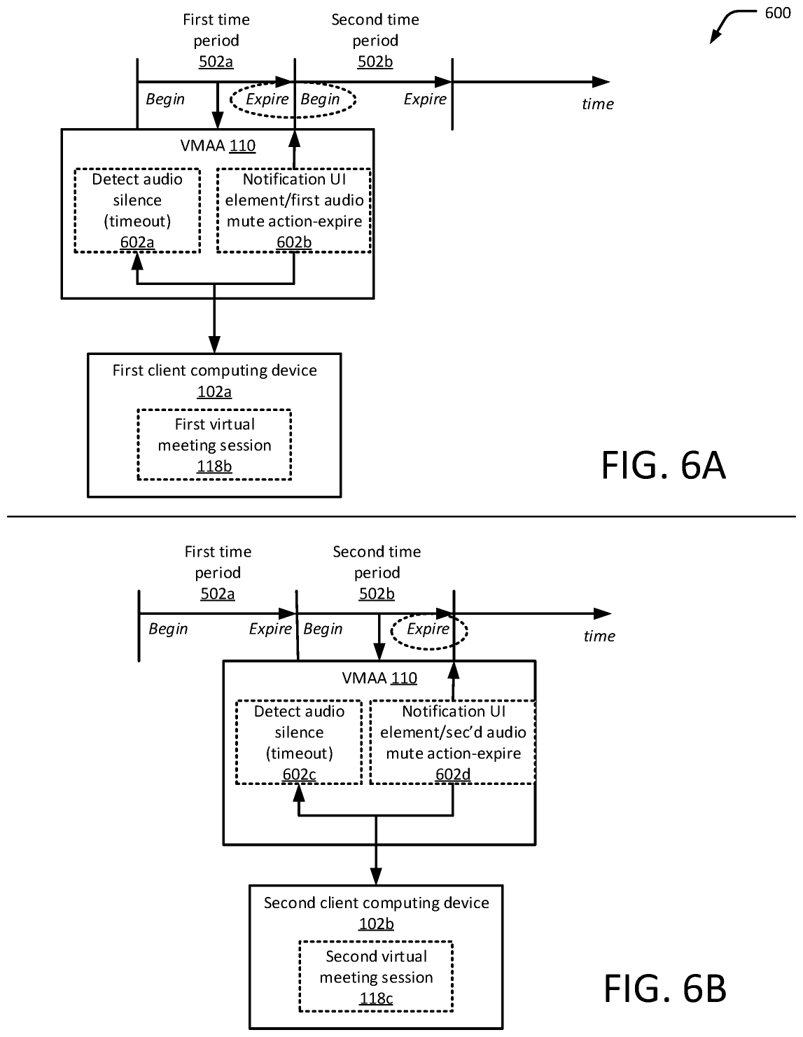

Next, the VMAA 110 renders 316 the meeting template 212 via the virtual meeting organizer session 118a so that the meeting organizer can view the template and confirm 318 that it is the correct template for the virtual meeting, provide a user input to modify the template to suit the organizer's needs for the virtual meeting, or dismiss the template if the organizer does not wish to use any template. Once the meeting template is either confirmed or modified by the virtual meeting organizer session 118a, then the VMAA 110 executes 320 the one or more rules defined by the meeting template, such as described in further detail with respect to FIGS. 5A, 5B, 6A, and 6B.

### Example Virtual Meeting Control

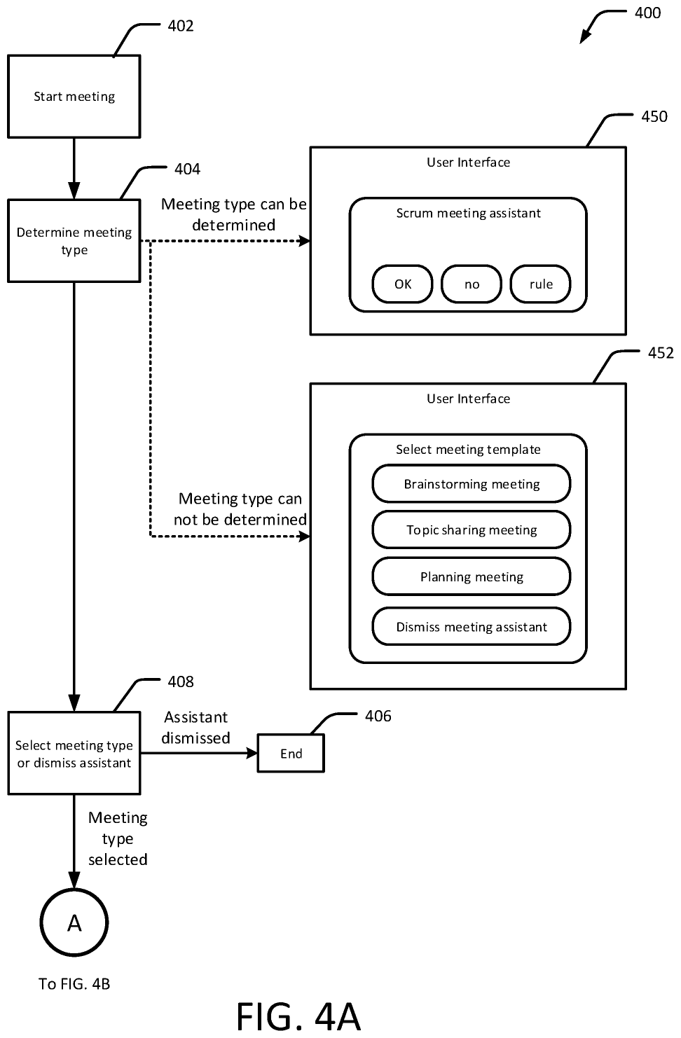

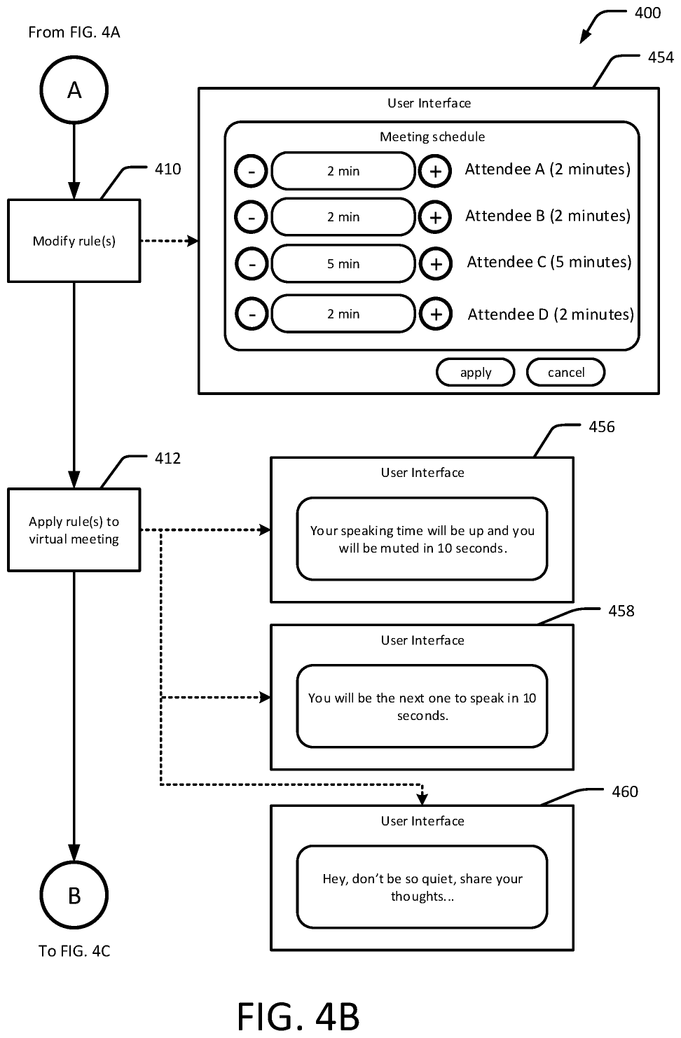

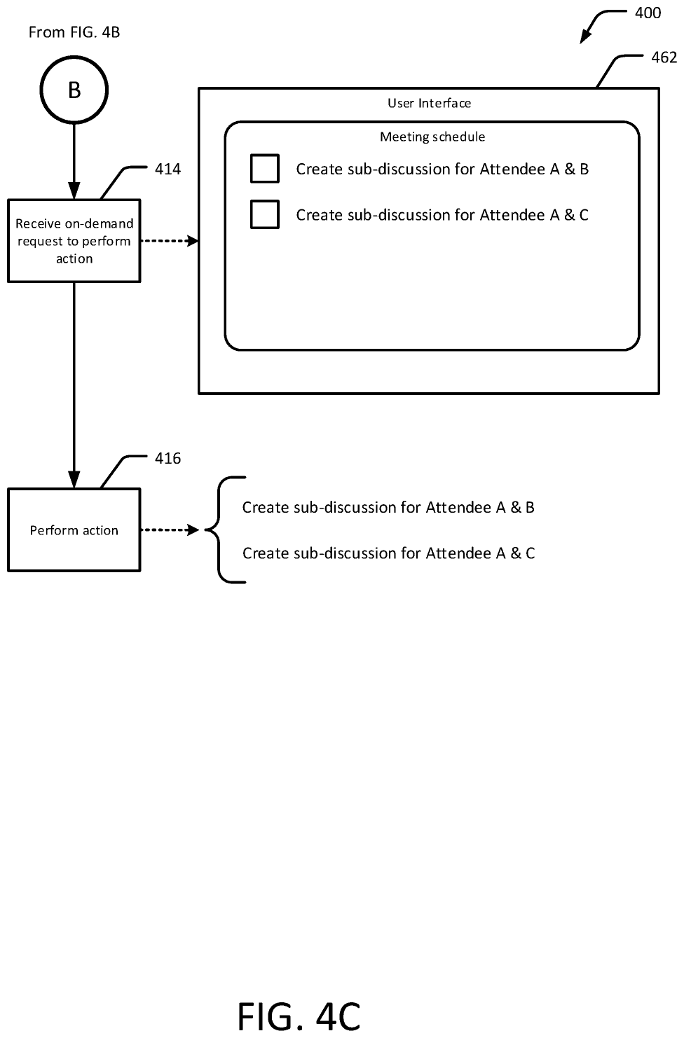

FIGS. 4A-C show a flow diagram of an example virtual meeting control process 400, in accordance with an example of the present disclosure. At least some portions of the process 400 can be implemented by the VMCA 112 in conjunction with the VMAA 110. Initially, as shown in FIG. 4A, a virtual meeting is started 402 by the meeting organizer. The VMCA 112 hosts the virtual meeting via the virtual meeting organizer/attendee sessions 118, 118a, 118b. Next, the meeting type is determined 404 by the VMAS 116. As described above, the VMAA 110 receives the meeting context data from the VMCA 112 and forwards it to the VMAS 116. In some examples, the VMAS 116 uses natural language processing to determine the meeting type using the meeting context data and to select an existing virtual meeting template 212 that most closely matches the meeting type, although it will be understood that other techniques can be utilized to select the virtual meeting template 212 that most closely matches the meeting context data. If the meeting type can be determined by the VMAS 116, the VMAA 110 causes a user interface 450 to be rendered via the virtual meeting organizer session 118a. The user interface 450 includes a dialog box or window that indicates the meeting type and provides one or more interactive user interface elements. For example, the user interface 450 can display a “scrum meeting assistant” (or other meeting type) and interactive user interface elements “ok” to confirm that the meeting type is correct and to use the default set of rules for conducting the virtual meeting, “no” to dismiss the VMAA 110 without further action, or “rule” to allow the organizer to modify the default rules for conducting the virtual meeting. An example of modifying the default rules is described with respect to FIG. 4B.

If the meeting type cannot be determined, the VMAA 110 causes a user interface 452 to be rendered via the virtual meeting organizer session 118a. The user interface 452 includes a dialog box or window that provides one or more interactive user interface elements. For example, the user interface 452 can provide one or more buttons for selecting 408 the type of meeting, such as a brainstorming meeting, a topic sharing meeting, and a planning meeting. In some examples, a button can be provided for dismissing the user interface 452 (e.g., a “dismiss meeting assistant” button) without selecting any meeting type. If the user interface 452 is dismissed, then the process 400 ends at 406. However, if a meeting type is selected from within the user interface 450 or 452, the process 400 continues as shown in FIG. 4B.

A default set of rules is associated with the selected meeting type. These rules can define, for example, the virtual meeting attendees and how much time each attendee is allocated for speaking during the virtual meeting. For example, the default rules can define that, for each of four attendees (e.g., Attendees A, B, C, and D), each attendee is allocated two minutes to speak during the virtual meeting. Referring to FIG. 4B, the process 400 includes optionally modifying 410 one or more of the rules associated with the selected meeting type. Using the prior example, the organizer of the virtual meeting can change the amount of time allocated to any of the attendees (e.g., the default of two minutes of speaking time for Attendee C is changed to five minutes of speaking time, and the remaining attendees are allocated two minutes of speaking time each). The VMAA 110 causes a user interface 454 to be rendered via the virtual meeting organizer session 118a. The user interface 454 includes a dialog box or window that provides one or more interactive user interface elements. For example, the user interface 454 can provide one or more buttons for changing the allocated speaking times of each attendee (e.g., buttons to increment or decrement the time). In some examples, a button can be provided for accepting the changes (e.g., an “apply” button) or dismissing the changes (e.g., a “cancel” button) without changing any of the speaking times.

The rule(s), whether default or modified, are then applied 412 to the virtual meeting. For example, if Attendee A is allocated two minutes of speaking time, the VMAA 110 causes a user interface 456 to be rendered via the virtual meeting attendee session 118b associated with Attendee A. The user interface 456 includes a dialog box or window that provides a notification of speaking time remaining. For example, the user interface 456 can notify the attendee who is speaking that his or her speaking time is about to expire. If the rule is defined to mute the virtual meeting attendee session 118b at the expiration of the allocated speaking time, then the notification in the user interface 456 indicates such. In another example, if Attendee A is allocated two minutes of speaking time, the VMAA 110 causes a user interface 458 to be rendered via the virtual meeting attendee session 118b associated with Attendee B, who is the attendee scheduled to speak after Attendee A's speaking time has expired. The user interface 458 includes a dialog box or window that provides a notification of time remaining until Attendee B's speaking time begins. In yet another example, if Attendee A is not speaking (no audio detected) for a pre-determined period (e.g., 10 seconds or longer) during his or her allocated speaking time, the VMAA 110 causes a user interface 460 to be rendered via the virtual meeting attendee session 118b associated with Attendee A. The user interface 460 includes a dialog box or window that provides a suggestion to resume speaking. In some examples, if the attendee is silent for a pre-determined period, the corresponding virtual meeting attendee session 118b is muted to allow the next attendee to begin speaking. In some examples, the process 400 continues as shown in FIG. 4C.

Referring to FIG. 4C, according to some examples, the process 400 includes receiving 414 an on-demand request to perform an action within the virtual meeting. For example, the meeting organizer or any of the meeting attendees can, via the VMAA 110, request a sub-discussion or breakout meeting within the virtual meeting. A sub-discussion or breakout meeting can be, for example, a separate virtual meeting or collaboration between participants of the virtual meeting, where fewer than all of the meeting participants engage in a conversation that is not shared with all of the participants of the virtual meeting. In one example, the VMAA 110 causes a user interface 462 to be rendered via the virtual meeting attendee session 118a of the meeting organizer or the virtual meeting attendee session 118b of any of the meeting attendees. The user interface 462 includes a dialog box or window that provides one or more interactive user interface elements (e.g., check boxes, radio buttons, or other user-selectable elements) that correspond to one or more different sub-discussions. For example, the user interface 462 can provide a set of checkboxes for sub-discussions among different combinations of meeting participants, such as a sub-discussion between Attendees A and B and a sub-discussion between Attendees A and C. It will be understood that other actions can be implemented in a similar manner. Examples of other on-demand actions can include, for example, scheduling a future virtual meeting (such as a follow-up meeting), granting additional speaking time to one or more of the participants during the current virtual meeting (for instance, allocating additional speaking time to an attendee who has already used his or her allocated speaking time), generating an e-mail (such as an e-mail describing follow-up actions to be taken after the meeting concludes), and other such actions as will be appreciated in light of this disclosure. The meeting organizer and/or attendee can then select the interactive user interface element corresponding to the desired on-demand action. In response to receiving the on-demand request, the process 400 further includes performing 416 the action. The VMAA 110 can, for example, cause the VMCA 112 to create a sub-discussion or breakout meeting within the virtual meeting according to the requested action.

FIGS. 5A-B each show an example timeline 500 corresponding to execution 320, by the VMAA 110, of the one or more rules defined by the meeting template during a virtual meeting, in accordance with an example of the present disclosure. The virtual meeting can be segmented timewise into one or more consecutive time periods 502a, 502b, etc. As shown in FIG. 5A, the VMAA 110 performs a first audio unmute action 504a at the beginning of a first time period 502a. As noted above, the first time period 502a corresponds to the time allocated to a given meeting attendee (e.g., Attendee A) to speak during the virtual meeting. The amount of such speaking time is established by the rules in the virtual meeting template 212 of FIG. 2, as optionally modified by the meeting organizer. The first audio unmute action 504a is sent to a first endpoint computing device 102a and executed within a first virtual meeting session 118b. The first audio unmute action 504a causes the audio input of the first virtual meeting session 118b to become unmuted, allowing the first virtual meeting attendee to begin speaking within the virtual meeting (e.g., such that other participants can hear the audio from the first virtual meeting attendee). The VMAA 110 performs a first audio mute action 504b at the expiration of the first time period 502a (or, in some cases, earlier, such as described with respect to FIGS. 6A-B). The first audio mute action 504b is sent to the first endpoint computing device 102a and executed within the first virtual meeting session 118b. The first audio mute action 504b causes the audio input of the first virtual meeting session 118b to become muted, preventing the first virtual meeting attendee from continuing to speak within the virtual meeting.

As shown in FIG. 5B, the VMAA 110 performs a second audio unmute action 504c at the beginning of a second time period 502b. As noted above, the second time period 502b corresponds to the time allocated to a given meeting attendee (e.g., Attendee B) to speak during the virtual meeting. The amount of such speaking time is established by the rules in the virtual meeting template 212 of FIG. 2, as optionally modified by the meeting organizer. The second audio unmute action 504c is sent to a second endpoint computing device 102b and executed within a second virtual meeting session 118c. The second audio unmute action 504c causes the audio input of the second virtual meeting session 118c to become unmuted, allowing the second virtual meeting attendee to begin speaking within the virtual meeting (e.g., such that other participants can hear the audio from the second virtual meeting attendee). The VMAA 110 performs a second audio mute action 504d at the expiration of the second time period 502b. The second audio mute action 504d is sent to the second endpoint computing device 102b and executed within the second virtual meeting session 118c. The second audio mute action 504d causes the audio input of the second virtual meeting session 118c to become muted, preventing the second virtual meeting attendee from continuing to speak within the virtual meeting.

FIGS. 6A-B each show another example timeline 600 corresponding to execution 320, by the VMAA 110, of the one or more rules defined by the meeting template during a virtual meeting, in accordance with an example of the present disclosure. As noted above, the virtual meeting can be segmented timewise into one or more consecutive time periods 502a, 502b, etc. As shown in FIG. 6A, in one example, the VMAA 110 detects 602a audio silence (timeout) at the audio input of the first virtual meeting session 118b during the first time period 502a. As further noted above, the first time period 502a corresponds to the time allocated to a given meeting attendee (e.g., Attendee A) to speak during the virtual meeting. The amount of such audio silence is established by the rules in the virtual meeting template 212 of FIG. 2 and can be modified by the meeting organizer. If audio silence is detected (e.g., the attendee has not spoken for at least a pre-defined time period), then the first audio mute action 502b (see FIG. 5A) is sent to the first endpoint computing device 102a and executed within the first virtual meeting session 118b. The first audio mute action 504b causes the audio input of the first virtual meeting session 118b to become muted, preventing the first virtual meeting attendee from continuing to speak within the virtual meeting. In this example, the first audio mute action 504b can occur at or prior to the expiration of the first time period 502a. For instance, if the first virtual meeting attendee has 60 seconds of speaking time remaining in the first time period 502a, but has been silent for at least 10 consecutive seconds, then the VMAA 110 mutes the first virtual meeting session 118b and begins the second time period 502b immediately or within a threshold amount of time after detecting the audio silence (essentially preempting the remainder of the first time period 502a). In another example, at or prior to the expiration of the first time period 502a, the VMAA 110 issues 602b a notification user interface element to be rendered by the first virtual meeting session 118b via the first endpoint computing device 102a. For instance, the VMAA 110 can issue a notification, such as shown in FIG. 4B, that the first virtual meeting attendee's speaking time is about to expire (e.g., approximately 10 seconds before the expiration of the first time period 502a), which is displayed to the first virtual meeting attendee so he or she knows to wrap up speaking soon. Then, in some examples, at the expiration of the first time period 502a, the VMAA 110 mutes the first virtual meeting session 118b, such as described above. In some examples, the VMAA 110 can additionally or alternatively issue a notification, such as shown in FIG. 4B, to the second virtual meeting attendee via the second virtual meeting session 118c that his or her speaking time will begin next. In another example, the VMAA 110 can issue a notification, such as shown in FIG. 4B, suggesting or encouraging the first virtual meeting attendee to resume speaking if he or she has been silent for a pre-determined amount of time (e.g., 10 seconds). Other such notifications will be apparent in light of this disclosure.

As shown in FIG. 6B, in one example, the VMAA 110 detects 602c audio silence (timeout) at the audio input of the second virtual meeting session 118c during the second time period 502b. As noted above, the second time period 502b corresponds to the time allocated to a given meeting attendee (e.g., Attendee B) to speak during the virtual meeting. The amount of such audio silence is established by the rules in the virtual meeting template 212 of FIG. 2 and can be modified by the meeting organizer. If audio silence is detected (e.g., the attendee has not spoken for at least a pre-defined time period), then the second audio mute action 502d (see FIG. 5B) is sent to the second endpoint computing device 102b and executed within the second virtual meeting session 118c. The second audio mute action 504d causes the audio input of the second virtual meeting session 118c to become muted, preventing the first virtual meeting attendee from continuing to speak within the virtual meeting. In this example, the second audio mute action 504d can occur at or prior to the expiration of the second time period 502b. For instance, if the second virtual meeting attendee has 60 seconds of speaking time remaining in the second time period 502b, but has been silent for at least 10 consecutive seconds, then the VMAA 110 mutes the second virtual meeting session 118b immediately or within a threshold amount of time after detecting the audio silence (essentially preempting the remainder of the second time period 502b). In another example, at or prior to the expiration of the second time period 502b, the VMAA 110 issues 602d a notification user interface element to be rendered by the second virtual meeting session 118c via the second endpoint computing device 102b. For instance, the VMAA 110 can issue a notification, such as shown in FIG. 4B, that the second virtual meeting attendee's speaking time is about to expire (e.g., approximately 10 seconds before the expiration of the second time period 502b), which is displayed to the second virtual meeting attendee so he or she knows to wrap up speaking soon. Then, in some examples, at the expiration of the second time period 502b, the VMAA 110 mutes the second virtual meeting session 118c, such as described above. In another example, the VMAA 110 can issue a notification, such as shown in FIG. 4B, suggesting or encouraging the second virtual meeting attendee to resume speaking if he or she has been silent for a pre-determined amount of time (e.g., 10 seconds). Other such notifications will be apparent in light of this disclosure.

### Example Virtual Meeting Control Methodologies

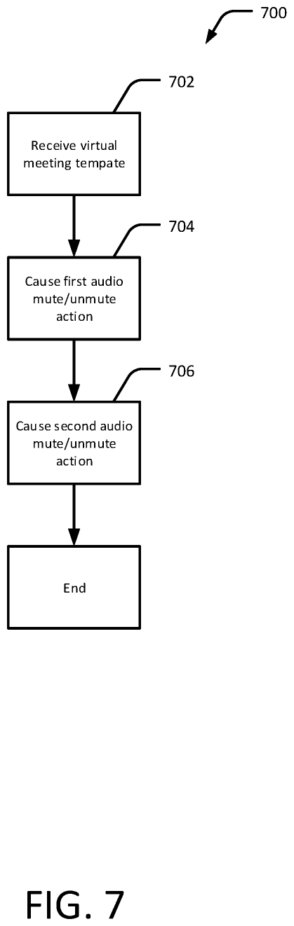

FIG. 7 is a flow diagram of an example virtual meeting control process 700, in accordance with an example of the present disclosure. The process 700 can be implemented, for example, by the VMAA 110. The process 700 includes receiving 702 a virtual meeting template (e.g., from the VMAS 116), which includes one or more rules that define the time when the audio for each of one or more virtual meeting sessions 118b is unmuted (at the beginning of a user's speaking period) and muted (at the end of a user's speaking period). As noted above, the rule(s) can be modified from the virtual meeting template, or the default rule(s) can be used without modification. The process 700 further includes causing 704 a first audio mute/unmute action to occur in a first virtual meeting session. The process 700 further includes causing 706 a second audio mute/unmute action to occur in a second virtual meeting session. For example, such as described with respect to FIGS. 5A-B and 6A-B, a first audio unmute action can occur at the beginning of the first time period allocated to the first virtual meeting session; a first audio mute action can occur at the expiration of the first time period; a second audio unmute action can occur at the beginning of the second time period allocated to the second virtual meeting session; and a second audio mute action can occur at the expiration of the second time period. In this manner, the first virtual meeting attendee is permitted to speak during the first time period and the second virtual meeting attendee is permitted to speak during the second time period.

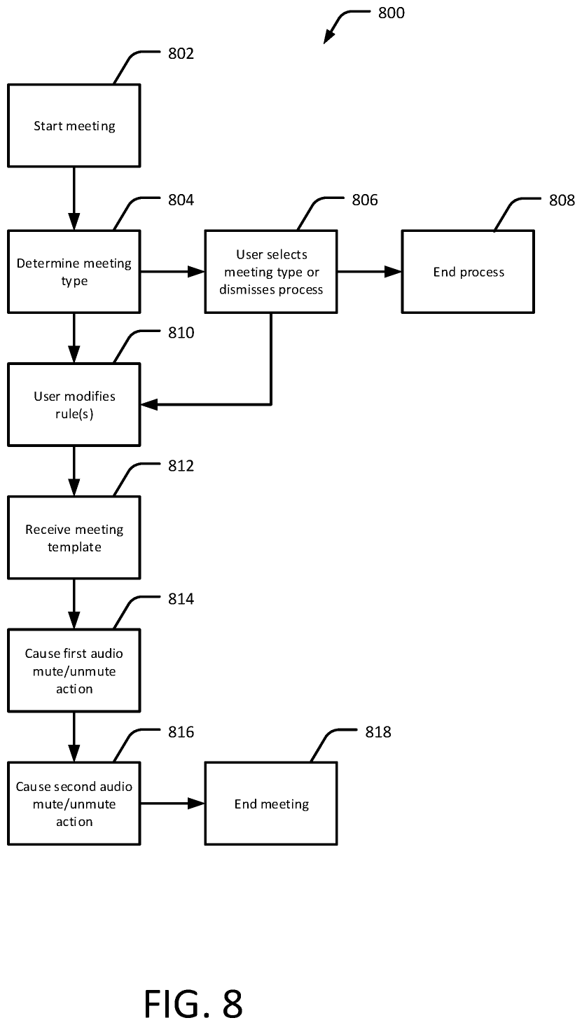

FIG. 8 is a flow diagram of another example virtual meeting control process 800, in accordance with an example of the present disclosure. The process 800 can be implemented, for example, by the VMAA 110, the VMCA 112, the VMAS 116, or any combination of these. The process 800 includes starting 802 a virtual meeting. The virtual meeting can be started, for example, by launching the VMCA 112. The process 800 further includes determining 804 the meeting type based on the meeting context, which is data describing the meeting (e.g., participant names or other identifying information, the date/time of the meeting, the subject of the meeting, and any other data corresponding to or otherwise describing or defining the virtual meeting). As discussed above, the VMAS 116 performs an analysis of the meeting context information and selects a meeting template 212 based on the analysis. For example, the VMAS 116 uses a natural language process to compare the meeting context information to one or more existing meeting templates 212 and to choose the template, if any, that most closely matches the meeting context information. If there is no meeting template that matches the meeting context, a user, such as the meeting organizer, selects 806 the meeting type manually, such as shown in the user interface 452 of FIG. 4A, or dismisses the process if the user does not wish to use any template, which ends 808 the process.

Once a meeting template is selected, the user can optionally modify 810 any of the meeting management rules associated with the template. As discussed above, the meeting management rules can, for example, define the time when the audio for each of one or more virtual meeting sessions is unmuted (at the beginning of a user's speaking period) and muted (at the end of a user's speaking period). Otherwise, the user can elect to use the default rules associated with the meeting template.

The process 800 further includes receiving 812 the meeting template at the VMAA 110. The VMAA 110 then executes the rules associated with the meeting template during the virtual meeting. For example, the process 800 can include causing 814 a first audio mute/unmute action to occur in a first virtual meeting session and causing 816 a second audio mute/unmute action to occur in a second virtual meeting session. For example, such as described with respect to FIGS. 5A-B and 6A-B, a first audio unmute action can occur at the beginning of the first time period allocated to the first virtual meeting session; a first audio mute action can occur at the expiration of the first time period; a second audio unmute action can occur at the beginning of the second time period allocated to the second virtual meeting session; and a second audio mute action can occur at the expiration of the second time period. The process 800 of causing mute/unmute actions can be repeated for any number of virtual meeting sessions, until each meeting attendee has had an opportunity to speak, at which point the meeting ends 818.

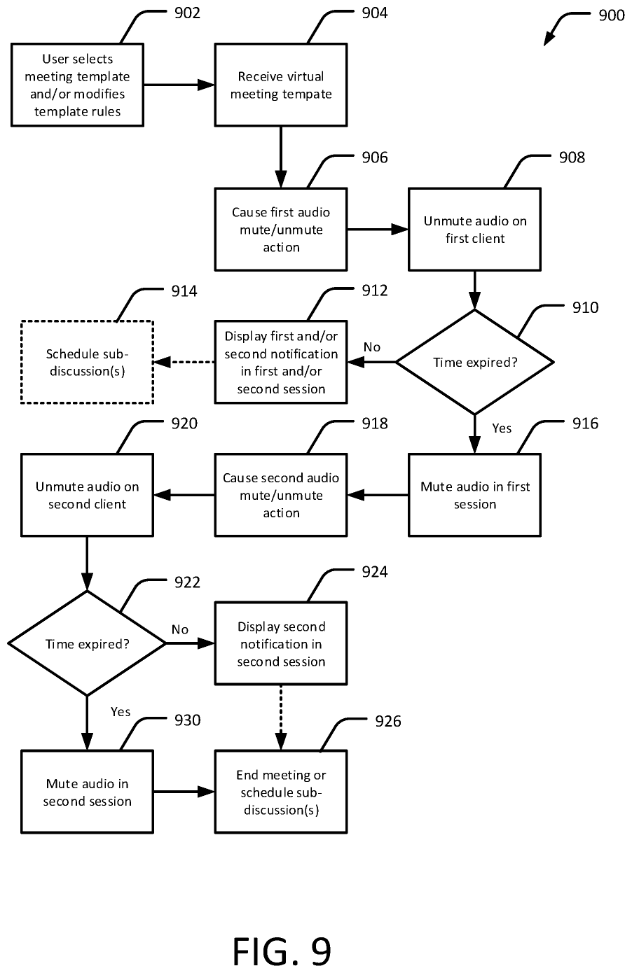

FIG. 9 is a flow diagram of another example virtual meeting control process 900, in accordance with an example of the present disclosure. The process 900 can be implemented, for example, by the VMAA 110, the VMCA 112, the VMAS 116, or any combination of these. The process 900 includes selecting 902 a meeting template with a set of default rules for conducting a virtual meeting and/or a meeting template with a set of user-modified rules for conducting the virtual meeting. For example, as discussed above, the meeting template can define a default first time period allocated to a first virtual meeting session, a default second time period allocated to a second virtual meeting session, and so forth. A virtual meeting organizer can, optionally, modify the length of any of the time periods, or use the default time periods. The method 900 further includes receiving 904, at the VMAA 110, the selected meeting template with the default rules or the user-modified rules. The VMAA 110 then executes the rules (default or modified) associated with the meeting template during the virtual meeting.

The process 900 include causing 906 a first audio mute/unmute action to occur in a first virtual meeting session. For example, such as described with respect to FIGS. 5A-B and 6A-B, a first audio unmute action 908 can occur at the beginning of the first time period allocated to the first virtual meeting session. If the first time period has not expired at 910, the process 900 can include displaying 912 a first notification in the first virtual meeting session. For example, if audio silence is detected in the first virtual meeting session (i.e., the first meeting attendee is not speaking), then the first notification can include suggesting that the first meeting attendee resume speaking, or that the first meeting attendee will be muted if he or she does not resume speaking within a pre-determined amount of time (e.g., within about 10 seconds). In another example, if the first time period is about to expire, the first notification can include a warning that the first meeting attendee will be muted within the pre-determined amount of time (e.g., about 10 seconds). Similarly, the process 900 can include displaying 912 a second notification in the second virtual meeting session. For example, if the first time period is about to expire, the second notification can include an advance warning that the second meeting attendee will be unmuted when it becomes his or her time to begin speaking. In some examples, the process 900 includes scheduling 914 one or more sub-discussions, such as by using the user interface shown in FIG. 4C. Scheduling a sub-discussion via the user interface allows at least some of the virtual meeting attendees to plan a separate meeting in the future without interrupting the first meeting attendee during the first time period.

If the first time period has expired, the process 900 includes muting 916 the audio input in the first virtual meeting session and causing 918 a second audio mute/unmute action to occur in a second virtual meeting session. For example, such as described with respect to FIGS. 5A-B and 6A-B, a second audio unmute action 920 can occur at the beginning of the second time period allocated to the second virtual meeting session. If the second time period has not expired at 922, the process 900 can include displaying 924 a second notification in the second virtual meeting session. For example, if audio silence is detected in the second virtual meeting session (i.e., the second meeting attendee is not speaking), then the second notification can include suggesting that the second meeting attendee resume speaking, or that the second meeting attendee will be muted if he or she does not resume speaking soon. In another example, if the second time period is about to expire, the second notification can include a warning that the second meeting attendee will be muted within a pre-determined amount of time (e.g., about 10 seconds). If the second time period has expired, the process 900 includes muting 930 the audio input in the second virtual meeting session. The process 900 can be repeated for any number of additional virtual meeting sessions until all meeting attendees have had a chance to speak, at which point the meeting ends 926 or one or more sub-discussions (as previously scheduled) begin.

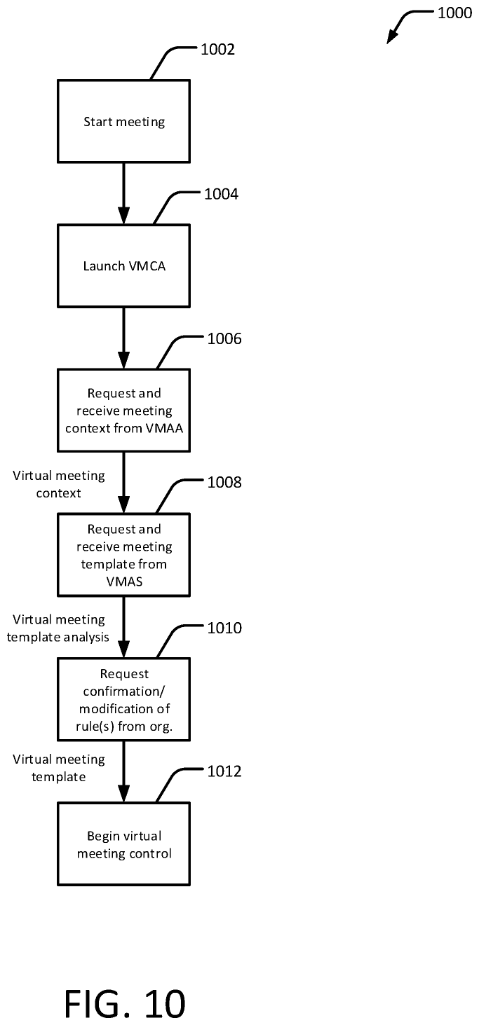

FIG. 10 is a flow diagram of another example virtual meeting control process 1000, in accordance with an example of the present disclosure. The process 1000 can be implemented, for example, by the VMAA 110, the VMCA 112, the VMAS 116, or any combination of these. The process 1000 includes starting 1002 a virtual meeting. The virtual meeting can be facilitated by launching 1004 the VMCA 112 (in conjunction with the VMAA 110 and the VMCA 112), as described above. The VMCA 112 requests and receives 1006 the meeting context from the VMAA 110. As noted above, the virtual meeting context can include data representing or otherwise describing the virtual meeting. The process 1000 further includes requesting and receiving 1008 a meeting template from the VMAS 116. As discussed above, the meeting template includes one or more rules that can be used by the VMAA 110 to control the virtual meeting. The process 1000 further includes requesting 1010 confirmation and/or a modification of the rules from the meeting organizer. For example, the VMAA 110 renders the meeting template 212 via the virtual meeting organizer session 118a so that the meeting organizer can view the template and confirm that it is the correct template for the virtual meeting, modify the template to suit the organizer's needs for the virtual meeting, or dismiss the template if the organizer does not wish to use any template. Once the meeting template is either confirmed or modified by the virtual meeting organizer session 118a, then the VMAA 110 begins 1012 control of the virtual meeting by, for example, executing the one or more rules defined by the meeting template, such as described in further detail with respect to FIGS. 5A, 5B, 6A, and 6B.

The foregoing description and drawings of various examples are presented by way of example only. These examples are not intended to be exhaustive or to limit the present disclosure to the precise forms disclosed. Alterations, modifications, and variations will be apparent in light of this disclosure and are intended to be within the scope of the present disclosure as set forth in the claims.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A method for controlling a virtual meeting, the method comprising:
receiving, by a virtual desktop application, a virtual meeting template including at least one template rule, the at least one template rule defining a first time period relating a first virtual meeting session of a first endpoint computing device and a second time period relating to a second virtual meeting session of a second endpoint computing device;
causing, by the virtual desktop application responsive to the at least one template rule, a first audio mute/unmute action to occur in the first virtual meeting session at or prior to an expiration of the first time period; and
causing, by the virtual desktop application responsive to the first audio mute action, a second audio mute/unmute action to occur in the second virtual meeting session at or prior to a start of the second time period, the second time period being different from the first time period.

2. The method of claim 1, wherein the first audio mute/unmute action includes causing an audio input on the first endpoint computing device to become muted in the first virtual meeting session and/or causing a first notification user interface element to be displayed in the first virtual meeting session of the first endpoint computing device.

3. The method of claim 2, further comprising detecting audio silence at the audio input during the first time period, wherein the first audio mute/unmute action occurs in response to detecting the audio silence.

4. The method of claim 2, wherein the first audio mute/unmute action further includes causing the audio input on the first endpoint computing device to become unmuted in the first virtual meeting session at a start of the first time period.

5. The method of claim 1, wherein the second audio mute/unmute action includes causing an audio input on the second endpoint computing device to become unmuted in the second virtual meeting session in response to causing an audio input on the first endpoint computing device to become muted in the first virtual meeting session, and/or causing a second notification user interface element to be displayed in the second virtual meeting session of the second endpoint computing device.

6. The method of claim 5, wherein the second audio mute/unmute action further includes causing the audio input on the second endpoint computing device to become muted in the second virtual meeting session at an expiration of the second time period.

7. The method of claim 1, further comprising selecting the virtual meeting template from among a plurality of virtual meeting templates by matching one or more parameters of the virtual meeting to one or more parameters of the virtual meeting template using a natural language processor.

8. The method of claim 1, further comprising receiving a user input modifying the first time period, the second time period, or both.

9. A computer program product including one or more non-transitory machine-readable mediums having instructions encoded thereon that when executed by at least one processor cause a process to be carried out, the process comprising:
receiving, by a virtual desktop application, a virtual meeting template including at least one template rule, the at least one template rule defining a first time period relating a first virtual meeting session of a first endpoint computing device and a second time period relating to a second virtual meeting session of a second endpoint computing device;
causing, by the virtual desktop application responsive to the at least one template rule, a first audio mute/unmute action to occur in the first virtual meeting session at or prior to an expiration of the first time period; and
causing, by the virtual desktop application responsive to the first audio mute action, a second audio mute/unmute action to occur in the second virtual meeting session at or prior to a start of the second time period, the second time period being different from the first time period.

10. The computer program product of claim 9, wherein the first audio mute/unmute action includes causing an audio input on the first endpoint computing device to become muted in the first virtual meeting session and/or causing a first notification user interface element to be displayed in the first virtual meeting session of the first endpoint computing device.

11. The computer program product of claim 10, wherein the process further comprises detecting audio silence at the audio input during the first time period, wherein the first audio mute/unmute action occurs in response to detecting the audio silence.

12. The computer program product of claim 10, wherein the first audio mute/unmute action further includes causing the audio input on the first endpoint computing device to become unmuted in the first virtual meeting session at a start of the first time period.

13. The computer program product of claim 9, wherein the second audio mute/unmute action includes causing an audio input on the second endpoint computing device to become unmuted in the second virtual meeting session in response to causing an audio input on the first endpoint computing device to become muted in the first virtual meeting session, and/or causing a second notification user interface element to be displayed in the second virtual meeting session of the second endpoint computing device.

14. The computer program product of claim 13, wherein the second audio mute/unmute action further includes causing the audio input on the second endpoint computing device to become muted in the second virtual meeting session at an expiration of the second time period.

15. The computer program product of claim 9, further comprising selecting the virtual meeting template from among a plurality of virtual meeting templates by matching one or more parameters of the virtual meeting to one or more parameters of the virtual meeting template using a natural language processor.

16. A system comprising:
a storage; and
at least one processor operatively coupled to the storage, the at least one processor configured to execute instructions stored in the storage that when executed cause the at least one processor to carry out a process including
receiving, by a virtual desktop application, a virtual meeting template including at least one template rule, the at least one template rule defining a first time period relating a first virtual meeting session of a first endpoint computing device and a second time period relating to a second virtual meeting session of a second endpoint computing device;
causing, by the virtual desktop application responsive to the at least one template rule, a first audio mute/unmute action to occur in the first virtual meeting session at or prior to an expiration of the first time period; and
causing, by the virtual desktop application responsive to the first audio mute action, a second audio mute/unmute action to occur in the second virtual meeting session at or prior to a start of the second time period, the second time period being different from the first time period.

17. The system of claim 16, wherein the first audio mute/unmute action includes causing an audio input on the first endpoint computing device to become muted in the first virtual meeting session and/or causing a first notification user interface element to be displayed in the first virtual meeting session of the first endpoint computing device.

18. The system of claim 17, wherein the process further comprises detecting audio silence at the audio input during the first time period, wherein the first audio mute/unmute action occurs in response to detecting the audio silence.

19. The system of claim 17, wherein the first audio mute/unmute action further includes causing the audio input on the first endpoint computing device to become unmuted in the first virtual meeting session at a start of the first time period.

20. The system of claim 16, wherein the second audio mute/unmute action includes causing an audio input on the second endpoint computing device to become unmuted in the second virtual meeting session in response to causing an audio input on the first endpoint computing device to become muted in the first virtual meeting session, and/or causing a second notification user interface element to be displayed in the second virtual meeting session of the second endpoint computing device, and wherein the second audio mute/unmute action further includes causing the audio input on the second endpoint computing device to become muted in the second virtual meeting session at an expiration of the second time period.
